(19) United States
(12) Patent Application Publication
(10) Pub. No.: US 2015/0023165 A1
(43) Pub. Date: Jan. 22, 2015

(54) COMMUNICATION DEVICE CAPABLE OF MEASURING AND INTERWORKING BETWEEN DIFFERENT RADIO TECHNOLOGIES AND METHOD THEREOF

(71) Applicant: ACER INCORPORATED, New Taipei City (TW)

(72) Inventor: Shiang-Rung YE, New Taipei City (TW)

(21) Appl. No.: 14/338,062

(22) Filed: Jul. 22, 2014

Related U.S. Application Data
(60) Provisional application No. 61/857,164, filed on Jul. 22, 2013.

(51) Int. Cl. H04W 28/02; H04W 28/08; H04W 36/00

(52) U.S. Cl. CPC H04W 28/0215; H04W 36/0094; H04W 28/08; H04W 88/06
USPC 370/230

(57) ABSTRACT

A communication device includes a first transceiving circuit, a second transceiving circuit and a processing circuit. The first transceiving circuit and the second transceiving circuit are respectively configured to communicate by utilizing a first radio access technology and a second radio access technology. The processing circuit is coupled with the first transceiving circuit and the second transceiving circuit for configuring the first transceiving circuit to receive a measurement control message from a first communication station to measure a signal quality of a second communication station. The processing circuit configures the second transceiving circuit to measure the signal quality of the second communication station when the first communication station is in a high traffic load condition or when the first communication station requests the communication device to offload at least some traffic load of data communications to the second communication station.

### CROSS-REFERENCE TO RELATED APPLICATIONS

This application claims the benefit of priority to U.S. Provisional Application Ser. No. 61/857,164, filed on Jul. 22, 2013; the entirety of which is incorporated herein by reference for all purposes.

### BACKGROUND

The disclosure generally relates to communication devices and, more particularly, to the communication devices with the interworking capability.

Nowadays, people are getting used to handling more and more tasks on the mobile communication devices, e.g., surfing the Internet, watching videos and instant messaging. The prevalence of the mobile communication devices and the accompanied radio resource requirement, however, introduce challenges for the network operators.

When the base station of the mobile network serves more user equipment, the data communication speed may degrade and not be acceptable for the users. Therefore, many researches have been carried on to offload the traffic load of the data communication (referred to as traffic load for conciseness hereinafter) in the communication network for improving the communication performance. For example, some researches propose that the communication network provides both the 3rd Generation Partnership Project (3GPP) radio access technologies and the wireless local area network (WLAN) radio access technologies for improving the system performance. The user equipment needs to choose a WLAN access appoint (AP) for offloading the traffic load to improve the data communication performance and reduce the loading of the base station. The user equipment, however, may not know whether the chosen WLAN AP is appropriate to offloading the traffic load. Therefore, the network resources still may not be utilized efficiently and effectively even with the interworking of the 3GPP radio access technologies and the WLAN radio access technologies.

### SUMMARY

In view of the foregoing, it may be appreciated that a substantial need exists for methods and apparatuses that mitigate or reduce the problems above.

An embodiment of a communication device is disclosed, comprising: a first transceiving circuit configured to operably communicate with a first communication station by utilizing a first radio access technology (RAT); a second transceiving circuit configured to operably communicate by utilizing a second RAT; and a processing circuit, coupled with the first transceiving circuit and the second transceiving circuit, configured to operably configure the first transceiving circuit to receive a measurement control message from the first communication station for measuring a signal quality of a second communication station; wherein the processing circuit configures the second transceiving circuit to measure the signal quality of the second communication station when the first communication station is in a high traffic load condition, when a traffic load of the first communication station is higher than a first predetermined threshold or when the first communication station requests the communication device to offload at least some traffic load of data communications to the second communication station.

Another embodiment of a communication device is disclosed, comprising: a first transceiving circuit configured to operably communicate with a first communication station by utilizing a first RAT; a second transceiving circuit configured to operably communicate with a second communication station by utilizing a second RAT; and a processing circuit, coupled with the first transceiving circuit and the second transceiving circuit, configured to operably configure the first transceiving circuit to receive a measurement control message from the first communication station for measuring a signal quality of the second communication station and a signal quality of a third communication station; wherein the processing circuit configures the second transceiving circuit to measure the signal quality of the second communication station and the signal quality of the third communication station when the second communication station is in a high traffic load condition, when the signal quality of the second communication station is lower than a predetermined threshold or when the communication device lost connections to the second communication station.

Another embodiment of communication method is disclosed, comprising: configuring a first transceiving circuit of a communication device to communicate with a first communication station by utilizing a first RAT; configuring a second transceiving circuit of the second communication device to communicate by utilizing a second RAT; configuring the first transceiving circuit to receive a measurement control message from the first communication station for measuring a signal quality of a second communication station; and configuring the second transceiving circuit to measure the signal quality of the second communication station when the first communication station is in a high traffic load condition, when a traffic load of the first communication station is higher than a first predetermined threshold or when the first communication station requests the communication device to offload at least some traffic load of data communications to the second communication station.

Another embodiment of communication method is disclosed, comprising: configuring a first transceiving circuit of a communication device to communicate with a first communication station by utilizing a first RAT; configuring a second transceiving circuit to communicate with a second communication station by utilizing a second RAT; configuring the first transceiving circuit to receive a measurement control message from the first communication station for measuring a signal quality of the second communication station and a signal quality of a third communication station; and configuring the second transceiving circuit to measure the signal quality of the second communication station and the signal quality of the third communication station when the second communication station is in a high traffic load condition, when the signal quality of the second communication station is lower than a predetermined threshold or when the communication device lost connections to the second communication station.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a communication system according to one embodiment of the present disclosure.

FIG. 2 shows a simplified flowchart of a traffic load steering method according to one embodiment of the present disclosure.

FIG. 3 shows a simplified functional block diagram of a communication system according to another embodiment of the present disclosure.

FIG. 4 shows a simplified flowchart of a traffic load steering method according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

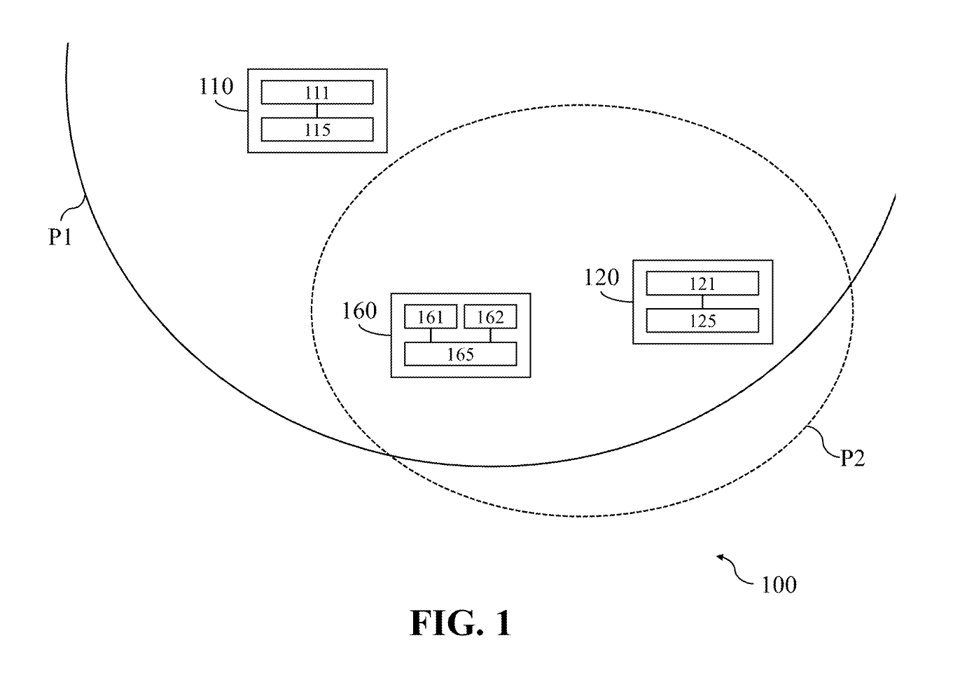

FIG. 1 shows a simplified functional block diagram of a communication system 100 according to one embodiment of the present disclosure. In this embodiment, the communication system 100 comprises two communication stations 110 and 120 and a communication device 160. For the purposes of conciseness and clear explanation, some components and connections of the communication system 100 are not shown in FIG. 1. For example, there may be more communication stations and more communication devices in the communication system 100.

In the following embodiments, the communication stations 110 and 120 may respectively communicate with the communication devices by utilizing at least one of a first radio access technology (RAT) and a second RAT. The first RAT may be configured to utilize one or more wireless wide area network (WWAN), wireless metropolitan area network (WMAN), or other suitable radio access technologies (RATs) with a wider communication range, e.g., WiMAX, GSM, UMTS, I-ISPA, LTE, LTE-Advanced and other 3GPP RATs. The second RAT may be configured to utilize one or more wireless local area network (WLAN), or other suitable RATs with a shorter communication range (compared with the first RAT), e.g., IEEE 802.11 series RATs.

Moreover, in the following embodiments, the communication stations 110 and 120 are the neighboring communication stations to each other. Namely, at least part of the communication range of a communication station overlaps at least part of the communication ranges of its neighboring communication station. For example, as shown in FIG. 1, part of the communication range P1 of the communication station 110 overlaps part of the communication range P2 of the communication station 120.

The communication station 110 comprises a transceiving circuit 111 and a processing circuit 115. The communication station 120 comprises a transceiving circuit 121 and a processing circuit 125.

The transceiving circuits 111 and 121 may respectively comprise the antenna, the modulator, the demodulator, the analog signal processing circuits, and/or the digital processing circuits for performing communications with communication devices. The transceiving circuit 111 is configured to operably communicate with communication devices by utilizing the first RAT. The transceiving circuit 121 is configured to operably communicate with communication devices by utilizing the second RAT.

The processing circuits 115 and 125 may be realized with the microprocessor, the network processor, the analog signal processing circuits, the digital signal processing circuits, and/or other suitable circuit elements. The processing circuits 115 and 125 are respectively coupled with the transceiving circuits 111 and 121 for performing suitable operations.

For the purpose of conciseness, in the following embodiments, the first RAT is configured to be at least one of the 3GPP RATs and the second RAT is configured to be at least one of the IEEE 802.11 series RATs. Thus, the communication station 110 is configured to comprise a 3GPP base station (BS), e.g., node B and evolved node B. The communication station 120 is configured to comprise an IEEE 802.11 series wireless local area network access point (WLAN AP).

The communication stations 110 and 120 are respectively coupled with the network (not shown in FIG. 1). The network may be realized with one or more wired networks and wireless networks, and may comprise the backhaul network, the core network, the gateway, servers and/or other network equipment (not shown in FIG. 1).

The communication device 160 comprises a first transceiving circuit 161, a second transceiving circuit 162 and a processing circuit 165.

The transceiving circuits 161 and 162 may respectively comprise the antenna, the modulator, the demodulator, the analog signal processing circuits, and/or the digital processing circuits for performing communications with communication stations. The transceiving circuit 161 is configured to operably communicate with communication stations by utilizing the first RAT. The transceiving circuit 162 is configured to operably communicate with communication stations by utilizing the second RAT.

The processing circuit 165 may be realized with the microprocessor, the network processor, the analog signal processing circuits, the digital signal processing circuits, and/or other suitable circuit elements. The processing circuit 165 is coupled with the transceiving circuit 161 and 162 for performing suitable operations.

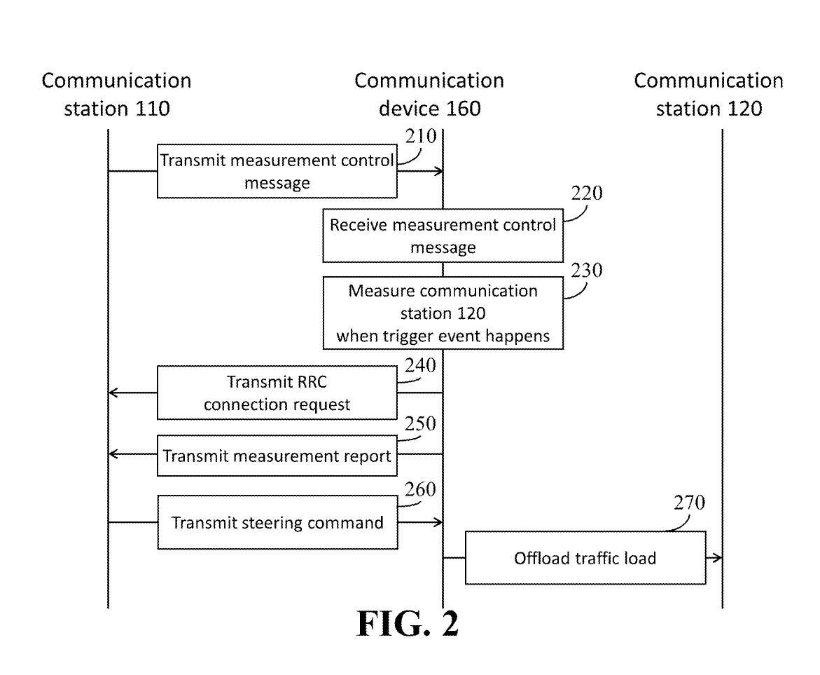

FIG. 2 shows a simplified flowchart of a traffic load steering method according to one embodiment of the present disclosure. The operations of the communication system 100 are explained in more details below with FIGS. 1 and 2.

When associated with the communication station utilizing the first RAT, if the communication device does not perform the measurement and the reporting of the communication station utilizing the second RAT in an appropriate time, the radio resource may be wasted on the inefficient measurement and reporting.

In FIG. 2, the traffic load steering method may effectively and efficiently offload the traffic load of the communication device to a suitable choice of the WLAN APs. Moreover, the measurement and the reporting may be performed in an appropriate time. In this embodiment, the communication device 160 is associated with the communication station 110 but not yet associated with the communication station 120 in the beginning.

In the operation 210, the processing circuit 115 of the communication station 110 configures the transceiving circuit 111 to transmit a measurement control message to the communication device 160 for signaling the communication device 160 to measure the signal quality of the communication station(s) utilizing the second RAT in an appropriate time, e.g., the communication station 120 and other WLAN APs (not shown in FIG. 1). The measurement control message may be transmitted by utilizing the broadcast message to multiple communication devices or by utilizing the dedicated message intended for a designated communication device.

For example, the signal quality may be configured to be the received channel power indicator (RCPI), the received signal to noise indicator (RSNI), the received signal strength indicator (RSSI), the reference signal receiving power (RSRP), the reference signal receiving quality (RSRQ), or other suitable indicator for estimating the signal quality.

In the operation 220, the processing circuit 165 of the communication device 160 configures the transceiving circuit 161 to receive the measurement control message from the communication station 110 for measuring the signal quality of the communication stations utilizing the second RAT in an appropriate time.

In the operation 230, when a trigger event happens, the processing circuit 165 configures the transceiving circuit 162 to measure the signal quality of the communication station(s) utilizing the second RAT (e.g., measure the signal quality of the communication station 120). The trigger events may be configured to be (1) that the serving communication station utilizing the first RAT (i.e., the communication station 110 in this embodiment) is in a high traffic load condition (2) that the traffic load of the serving communication station utilizing the first RAT is higher than a first predetermined threshold or (3) that the serving communication station utilizing the first RAT requests the communication device 160 to offload at least part of the traffic load of the data communications to the communication station utilizing the second RAT (e.g., the communication station 120 in this embodiment). Moreover, the communication station 110 may signal its high traffic load condition, transmit the traffic load and the first predetermined threshold or request the communication device 160 to offload the traffic load by utilizing the broadcast message or the dedicated message. The signal quality of the communication stations utilizing the second RAT may be determined by the processing circuit 165 of the communication device 160 according to the signals received by the transceiving circuit 162.

Moreover, the communication station 110 may signal its high traffic load condition to the communication device 160 by any feasible manner. For example, in one embodiment, the communication station 110 may signal its traffic load and the first predetermined threshold by utilizing the broadcast message or the dedicate message, and the communication device determines the communication station 110 is in the high traffic load condition when the traffic load of the communication station 110 is higher than the first predetermined threshold. Furthermore, the high traffic load condition, the traffic load of the serving communication station utilizing the first RAT and the first predetermined threshold may be respectively expressed as a number, a percentage, a load level, or other suitable indicators. In other embodiments, the communication station 110 may also signal the high traffic load condition by utilizing a message (either the broadcast message or the dedicated message) or a bit of a message that indicate it is in the high traffic load condition.

In the operation 240, the processing circuit 165 of the communication device 160 configures the transceiving circuit 161 to transmit a radio resource control (RRC) connection request to the communication station 110.

In the operation 250, the processing circuit 165 of the communication device 160 configures the transceiving circuit 161 to transmit the measurement report of at least part of the signal quality of the communication station(s) utilizing the second RAT to the communication station 110 by utilizing the RRC connection when the reporting criterion is met. For example, in this embodiment, the reporting criterion may be configured to be at least one of that the signal quality of the communication station 120 is higher than a second predetermined threshold and that the traffic load of the communication station 120 is lower than a third predetermined threshold. The communication station utilizing the second RAT, e.g., the IEEE802.11 series WLAN AP, may provide the traffic load information to the communication devices by utilizing the broadcast message or the dedicated message.

In the operation 260, the processing circuit 115 of the communication station 110 configures the transceiving circuit 111 to transmit a steering command for signaling the communication device 160 to offload at least some traffic load to the communication station 120 (assumed that the communication station 120 is the suitable communication station utilizing the second RAT chosen for offloading the traffic load).

In the operation 270, the processing circuit 165 of the communication device 160 configures the transceiving circuit 162 to offload at least some traffic load to the communication station 120.

In other embodiments in the operation 240, when the RRC connection between the communication station 110 and the communication device 160 has been previously established, the operation 240 may be omitted.

In other embodiments in the operations 250 and 260, the measurement report may be expressed in any suitable manner. For example, the measurement report may comprises a number indicating the signal quality of the communication station 120 and one or more bits indicating whether the communication station is a good choice for offloading the traffic load, etc. Moreover, in other embodiments in the operations 250 and 260, the comparison of the signal quality of the communication station 120 and the second predetermined threshold and the comparison of the traffic load of the serving communication station utilizing the first RAT and the third predetermined threshold may also be carried out in the communication device 160 and the comparison result is transmitted in the measurement report to the communication station 110.

In the above embodiments, the first, the second and the third predetermined thresholds may be configured to be the same or different according to different design considerations.

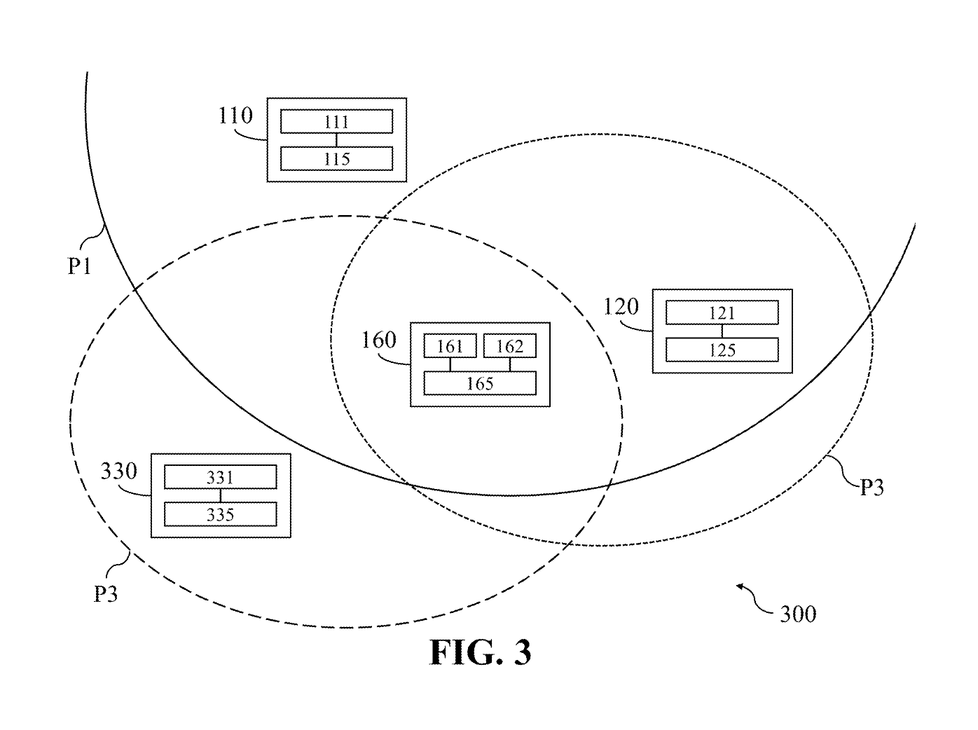

FIG. 3 shows a simplified functional block diagram of a communication system 300 according to another embodiment of the present disclosure. In this embodiment, the communication system 300 comprises three communication stations 110, 120 and 330 and a communication device 160. For the purposes of conciseness and clear explanation, some components and connections of the communication system 300 are not shown in FIG. 3. For example, there may be more communication stations and communication devices in the communication system 300.

The communication stations 110 and 120 and the communication device 160 in the communication system 300 may be respectively configured to be the same or similar to the counterparts in the communication system 100. Relevant descriptions may be referred to in the above paragraphs and are therefore omitted for conciseness.

In this embodiment, the communication station 330 is configured to communicate with the communication devices by utilizing the second RAT. Moreover, the communication stations 110, 120 and 330 are the neighboring communication stations to one another. As shown in FIG. 3, part of the communication range P1 of the communication station 110, part of the communication range P2 of the communication station 120 and part of the communication range P3 of the communication station 330 are overlapped.

The communication station 330 comprises a transceiving circuit 331 and a processing circuit 335. The transceiving circuit 331 may comprise the antenna, the modulator, the demodulator, the analog signal processing circuits, and/or the digital processing circuits for performing communications with communication devices. The transceiving circuit 331 is configured to operably communicate with communication devices by utilizing the second RAT. The processing circuit 335 may be realized with the microprocessor, the network processor, the analog signal processing circuits, the digital signal processing circuits, and/or other suitable circuit elements. The processing circuit 335 is coupled with the transceiving circuits 331 for performing suitable operations.

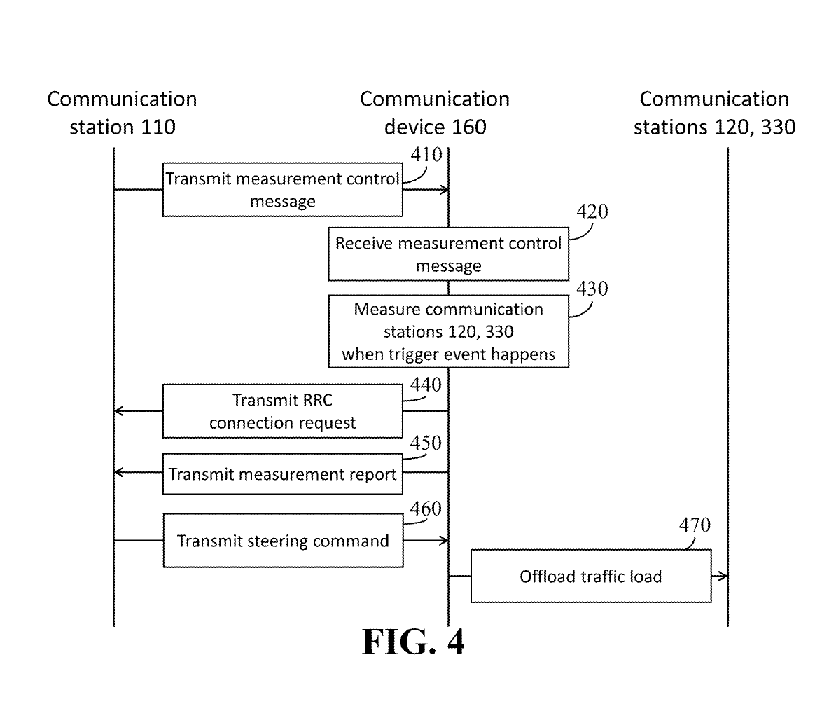

FIG. 4 shows a simplified flowchart of a traffic load steering method according to another embodiment of the present disclosure. The operations of the communication system 300 are explained in more details below with FIGS. 3 and 4.

in this embodiment, the communication device 160 is associated with the communication station 110 and already associated with the communication station 120 for offloading the traffic load in the beginning. In the following embodiment, the communication station 120 is configured to be the serving communication station utilizing the second RAT and the communication station 130 is configured to the neighboring communication station utilizing the second RAT in the beginning. In FIG. 4, the traffic load steering method may effectively and efficiently offload the traffic load of the communication device to the suitable choice of the communication station utilizing the second RAT even when the communication device is previously associated with one communication station utilizing the second RAT. Moreover, the measurement and the reporting may still be performed in an appropriate time.

In the operation 410, the processing circuit 115 of the communication station 110 configures the transceiving circuit 111 to transmit a measurement control message to the communication device 160 for signaling the communication device 160 to measure the signal quality of the communication stations utilizing the second RAT in an appropriate time, e.g., the serving communication station 120, the neighboring communication station 330 and other WLAN APs (not shown in FIG. 3). The measurement control message may be transmitted by utilizing the broadcast message to multiple communication devices or utilizing the dedicated message intended for a designated communication device.

In the operation 420, the processing circuit 165 of the communication device 160 configures the transceiving circuit 161 to receive the measurement control message from the communication station 110 for measuring the signal quality of the communication stations utilizing the second RAT in an appropriate time.

In the operation 430, when a trigger event happens, the processing circuit 165 configures the transceiving circuit 162 to measure the signal quality of the communication stations utilizing the second RAT (e.g., measure the signal quality of the communication stations 120 and 330). The trigger events may be configured to be (1) that the serving communication station utilizing the second RAT (i.e., the communication station 120 in this embodiment) is in the high traffic load condition, (2) that the serving communication station utilizing the first RAT (i.e., the communication station 110 in this embodiment) and the serving communication station utilizing the second RAT are both in the high traffic load condition, (3) that the signal quality of the serving communication station utilizing the second RAT is lower than a fourth predetermined threshold, (4) that the signal quality of the serving communication station utilizing the first RAT and the signal quality of the serving communication station utilizing the second RAT are respectively lower than the fourth predetermined threshold and a fifth predetermined threshold, or (5) that the communication device 160 lost connections to the serving the communication station utilizing the second RAT. Moreover, the serving communication station utilizing the second RAT may signal its high traffic load condition by utilizing the broadcast message or the dedicated message. The signal quality of the serving communication station utilizing the first RAT, the signal quality of the communication stations utilizing the second RAT and the loss of connections to the serving communication station utilizing the second RAT may be respectively determined by the processing circuit 165 of the communication device 160 according to the signals received by the transceiving circuits 161 and 162.

The serving communication stations 110 and 120 may respectively signal their high traffic load conditions to the communication device 160 by any feasible manner. For example, in one embodiment, the serving communication stations 110 and 120 may respectively signal their traffic loads, a sixth predetermined threshold and a seventh predetermined threshold by utilizing the broadcast message or the dedicate message. Therefore, the communication device 160 determines whether the serving communication station is in the high traffic load condition when the traffic load of the serving communication station is higher than the predetermined threshold. Moreover, the high traffic load condition, the traffic load of the serving communication station and the predetermined threshold may be expressed as a number, a percentage, a load level, or other suitable indicators. In other embodiments, the serving communication stations 110 and 120 may also signal the high traffic load conditions respectively by utilizing a message (either the broadcast message or the dedicated message) or a bit of a message that indicate it is in the high traffic load condition.

In the operation 440, the processing circuit 165 of the communication device 160 configures the transceiving circuit 161 to transmit an RRC connection request to the communication station 110.

In the operation 450, the processing circuit 165 of the communication device 160 configures the transceiving circuit 161 to transmit the measurement report of at least part of the signal quality of the communication stations utilizing the second RAT to the communication station 110 by utilizing the RRC connection when the reporting criterion is met. For example, the reporting criterion may be configured to be that the traffic load of the serving communication station 120 is higher than an eighth predetermined threshold and the traffic load of the neighboring communication station 330 is lower than an ninth predetermined threshold. In another embodiment, the reporting criterion may be configured to be that the signal quality of the serving communication station 120 is lower than a tenth predetermined threshold and a signal quality of the neighboring communication station 330 is higher than an eleventh predetermined threshold.

In the operation 460, the processing circuit 115 of the communication station 110 configures the transceiving circuit 111 to transmit a steering command for signaling the communication device 160 to offload at least some traffic load to the chosen communication station utilizing the second RAT according to the measurement report.

In the operation 470, the processing circuit 165 of the communication device 160 configures the transceiving circuit 162 to offload at least some traffic load to the chosen communication station utilizing the second RAT according to the measurement report (e.g., determined by the communication station 110 according to the measurement report).

In other embodiments in the operation 440, when the RRC connection between the communication station 110 and the communication device 160 has been previously established, the operation 440 may be omitted.

In other embodiments in the operations 450 and 460, the measurement report may be expressed in any suitable manner. For example, the measurement report may comprises a number indicating the signal quality of the communication stations 120 and 330 and one or more bits indicating which communication station is the suitable choice for offloading the traffic load, etc. Moreover, in other embodiments in the operations 450 and 460, the comparison of the traffic load and the predetermined threshold and the comparison of the signal quality and the predetermined threshold may also be respectively carried out in the communication device 160 and the comparison result is transmitted in the measurement report to the communication station 110.

In the above embodiments, the predetermined thresholds may be respectively configured to be the same or different according to different design considerations.

In the above embodiments, the communication device may measure the signal quality of the communication station(s) utilizing the second RAT so as to offload the traffic load to a suitable communication station. The communication performance may therefore be effectively and efficiently improved.

In the above embodiments, the traffic load of the communication device may be effectively and efficiently offloaded to the communication station utilizing the second RAT with a lighter traffic load, and a better load balancing performance of the network may be achieved.

In the above embodiments, the communication device may measure the signal quality of the communications station utilizing the second RAT in an appropriate time (e.g., when the trigger event happens). Moreover, the communication device may transmit the measurement report when the reporting criterion is met. The computational power, the power consumption and the radio resource may therefore be conserved.

Certain terms are used throughout the description and the claims to refer to particular components. One skilled in the art appreciates that a component may be referred to as different names. This disclosure does not intend to distinguish between components that differ in name but not in function. in the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “The” herein are intended to comprise the plural forms as well, unless the context clearly indicates otherwise.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A communication device, comprising:
a first transceiving circuit configured to operably communicate with a first communication station by utilizing a first radio access technology (RAT);
a second transceiving circuit configured to operably communicate by utilizing a second RAT; and
a processing circuit, coupled with the first transceiving circuit and the second transceiving circuit, configured to operably configure the first transceiving circuit to receive a measurement control message from the first communication station for measuring a signal quality of a second communication station;
wherein the processing circuit configures the second transceiving circuit to measure the signal quality of the second communication station when the first communication station is in a high traffic load condition, when a traffic load of the first communication station is higher than a first predetermined threshold or when the first communication station requests the communication device to offload at least some traffic load of data communications to the second communication station.

2. The communication device of claim 1, wherein the first communication station signals the communication device the high traffic load condition by utilizing at least one of a broadcast message and a dedicated message to the communication device.

3. The communication device of claim 1, wherein the first communication station request the communication device to offload at least some traffic load of the data communications to the second communication station by utilizing at least one of a broadcast message and a dedicated message to the communication device.

4. The communication device of claim 1, wherein processing circuit configures the first transceiving circuit to transmit the signal quality of the second communication station to the first communication station when the signal quality of the second communication station is higher than a second predetermined threshold or when a traffic load of the second communication station is lower than a third predetermined threshold.

5. A communication device, comprising:
a first transceiving circuit configured to operably communicate with a first communication station by utilizing a first radio access technology (RAT);
a second transceiving circuit configured to operably communicate with a second communication station by utilizing a second RAT; and
a processing circuit, coupled with the first transceiving circuit and the second transceiving circuit, configured to operably configure the first transceiving circuit to receive a measurement control message from the first communication station for measuring a signal quality of the second communication station and a signal quality of a third communication station;
wherein the processing circuit configures the second transceiving circuit to measure the signal quality of the second communication station and the signal quality of the third communication station when the second communication station is in a high traffic load condition, when the signal quality of the second communication station is lower than a fourth predetermined threshold or when the communication device lost connections to the second communication station.

6. The communication device of claim 5, wherein the processing circuit configures the second transceiving circuit to measure the signal quality of the second communication station and the signal quality of the third communication station when the signal quality of the second communication station is lower than the fourth predetermined threshold and a signal quality of the first communication station is lower than a fifth predetermined threshold.

7. The communication device of claim 5, wherein the second communication station is in the high traffic load condition when a traffic load of the second communication station is higher than a sixth predetermined threshold.

8. The communication device of claim 5, wherein the processing circuit configures the second transceiving circuit to measure the signal quality of the second communication station and the signal quality of the third communication station when the second communication station is in the high traffic load condition and the first communication station is in a high traffic load condition.

9. The communication device of claim 8, wherein the second communication station is in the high traffic load condition when a traffic load of the second communication station is higher than a sixth predetermined threshold and the first communication station is in the high traffic load condition when a traffic load of the first communication station is higher than a seventh predetermined threshold.

10. The communication device of claim 5, wherein processing circuit configures the first transceiving circuit to transmit at least one of the signal quality of the second communication station and the signal quality of the third communication station to the first communication station when a traffic load of the second communication station is higher than an eighth predetermined threshold and a traffic load of the third communication station is lower than a ninth predetermined threshold.

11. The communication device of claim 5, wherein processing circuit configures the first transceiving circuit to transmit at least one of the signal quality of the second communication station and the signal quality of the third communication station when the signal quality of the second communication station is lower than a tenth predetermined threshold and the signal quality of the third communication station is higher than an eleventh predetermined threshold.

12. A communication method, comprising:
configuring a first transceiving circuit of a communication device to communicate with a first communication station by utilizing a first radio access technology (RAT);
configuring a second transceiving circuit of the second communication device to communicate by utilizing a second RAT;
configuring the first transceiving circuit to receive a measurement control message from the first communication station for measuring a signal quality of a second communication station; and
configuring the second transceiving circuit to measure the signal quality of the second communication station when the first communication station is in a high traffic load condition, when a traffic load of the first communication station is higher than a first predetermined threshold or when the first communication station requests the communication device to offload at least some traffic load of data communications to the second communication station.

13. The communication method of claim 12, wherein the first communication station signals the communication device the high traffic load condition by utilizing at least one of a broadcast message and a dedicated message to the communication device.

14. The communication method of claim 12, wherein the first communication station request the communication device to offload at least some traffic load of the data communications to the second communication station by utilizing at least one of a broadcast message and a dedicated message to the communication device.

15. The communication method of claim 12, further comprising:
configuring the first transceiving circuit to transmit the signal quality of the second communication station to the first communication station when the signal quality of the second communication station is higher than a second predetermined threshold or when a traffic load of the second communication station is lower than a third predetermined threshold.

16. A communication method, comprising:
configuring a first transceiving circuit of a communication device to communicate with a first communication station by utilizing a first radio access technology (RAT);
configuring a second transceiving circuit to communicate with a second communication station by utilizing a second RAT;
configuring the first transceiving circuit to receive a measurement control message from the first communication station for measuring a signal quality of the second communication station and a signal quality of a third communication station; and
configuring the second transceiving circuit to measure the signal quality of the second communication station and the signal quality of the third communication station when the second communication station is in a high traffic load condition, when the signal quality of the second communication station is lower than a fourth predetermined threshold or when the communication device lost connections to the second communication station.

17. The communication method of claim 16, further comprising:
configuring the second transceiving circuit to measure the signal quality of the second communication station and the signal quality of the third communication station when the signal quality of the second communication station is lower than the fourth predetermined threshold and a signal quality of the first communication station is lower than a fifth predetermined threshold.

18. The communication method of claim 16, wherein the second communication station is in the high traffic load condition when a traffic load of the second communication station is higher than a sixth predetermined threshold.

19. The communication method of claim 16, further comprising:
configuring the second transceiving circuit to measure the signal quality of the second communication station and the signal quality of the third communication station when the second communication station is in the high traffic load condition and the first communication station is in a high traffic load condition.

20. The communication method of claim 19, wherein the second communication station is in the high traffic load condition when a traffic load of the second communication station is higher than a sixth predetermined threshold and the first communication station is in the high traffic load condition when a traffic load of the first communication station is higher than a seventh predetermined threshold.

21. The communication method of claim 16, further comprising:
configuring the first transceiving circuit to transmit at least one of the signal quality of the second communication station and the signal quality of the third communication station to the first communication station when a traffic load of the second communication station is higher than an eighth predetermined threshold and a traffic load of the third communication station is lower than a ninth predetermined threshold.

22. The communication method of claim 18, further comprising:
configuring the first transceiving circuit to transmit at least one of the signal quality of the second communication station and the signal quality of the third communication station when the signal quality of the second communication station is lower than a tenth predetermined threshold and the signal quality of the third communication station is higher than an eleventh predetermined threshold.
